(19) United States
(12) Patent Application Publication
(10) Pub. No.: US 2012/0173277 A1
(43) Pub. Date: Jul. 5, 2012

(54) Healthcare Quality Measure Management

(75) Inventors: Peter Harrison Yates, Kansas City, MO (US); Sara Jane Charlson, Smithville, MO (US)

(73) Assignee: CERNER INNOVATION, INC., Overland Park, KS (US)

(21) Appl. No.: 12/982,126

(22) Filed: Dec. 30, 2010

(51) Int. Cl. G06Q 50/00

(52) U.S. Cl. 705/3; 705/2

(57) ABSTRACT

Methods and systems for managing healthcare quality measure data are provided. Relevant quality measure data relating to a patient with a particular condition is identified, and it is determined if patient qualifies for a standardized quality measure related to that condition. If the patient qualifies, the relevant quality measure data is populated into a work queue associated with a computing device and displayed to a user. The relevant quality measure may be approved and sent to a quality clearinghouse. If the relevant quality measure data is not approved, additions, deletions, or changes are made to generate a revised set of relevant quality measure data which is then sent to the quality clearinghouse. The approved relevant quality measure data is received by the quality clearinghouse, and a recipient is selected to receive the relevant quality measure data. The relevant quality measure data is reformatted to the specifications of the recipient and is sent to the recipient.

### BACKGROUND

Improving the quality of healthcare is at the forefront of today's news. One way to improve the quality of healthcare is to track healthcare quality measure data for a wide range of patients in order to provide feedback to providers. There are numerous national and/or state data organizations that track and analyze healthcare quality measure data and provide the needed feedback to providers. But, currently, the management of the healthcare quality measure data at the provider setting is fraught with problems. The process of compiling the quality measure data is often done manually which is time-intensive, expensive, and laden with errors. In addition, the gathering of the quality measure data often does not begin until long after a patient has been discharged or is otherwise unavailable to the provider or the person compiling the quality measure data.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The present invention is defined by the claims.

One embodiment of the present invention is directed towards a system that has a an identification component that identifies relevant quality measure data for a patient with a particular condition, where relevant quality measure data is data required to calculate category assignments and measurements for a standardized quality measure for the particular condition. A determining component determines whether the patient qualifies for the standardized quality measure for the particular condition by comparing the relevant quality measure data for the patient to criteria qualifications for the standardized quality measure for the particular condition. In addition, a populating component populates the relevant quality measure data for the qualified patient into a work queue to be reviewed, and a displaying component displays the relevant quality measure data to a user, such as an abstractor, for approval or disapproval. Further, an alerting component alerts the user or a provider if the user does not approve the relevant quality measure data, and a communication component communicates the approved relevant quality measure data to a quality clearinghouse.

Another aspect of the present invention is directed toward a system that has a receiving component that receives the relevant quality measure data, and a determining component that determines a recipient of the relevant quality measure data. In addition, there is a reformatting component that reformats the relevant quality measure data according to the specifications of the recipient, and a communication component that communicates the reformatted relevant quality measure data to the recipient.

The present invention also relates to methods embodied on computer-readable media for managing quality measure data related to healthcare. In one aspect of the invention, relevant quality measure data for a patient is obtained, and it is determined whether the patient meets criteria to be reviewed. If the patient does meet the criteria to be reviewed, the relevant quality measure data for the patient is populated into a work queue associated with a computing device. The relevant quality measure data for the patient is displayed to a user of the computing device, and approval of the relevant quality measure data may be received. If approval is received, the approved relevant quality measure data for the patient is sent to a quality clearinghouse. If approval is not obtained, additions, deletions, or changes to the relevant quality measure data are received to generate a revised set of relevant quality measure data. It is then determined if additional review is necessary. If additional review is necessary, the process starts over from the beginning. If additional review is not necessary, the revised set of relevant quality measure data is sent to the quality clearinghouse.

In another aspect of the invention, a computer-implemented method for managing quality measure data related to healthcare using a quality clearinghouse is provided. A set of approved relevant quality measure data is received by a quality clearinghouse. A recipient of the quality measure values is selected, and the set of relevant quality measure data is reformatted to the specifications of the recipient to produce a reformatted set of relevant quality measure data. The reformatted relevant quality measure data is then sent to the selected recipient.

### BRIEF DESCRIPTION OF THE DRAWINGS

Embodiments are described in detail below with reference to the attached drawing figures, wherein:

FIG. 1 is a block diagram of an exemplary computing environment suitable to implement embodiments of the present invention;

FIG. 2 is an example of system architecture suitable to implement embodiments of the present invention;

FIG. 3 is a flow diagram of a method for managing healthcare quality measure data using an abstractor service in accordance with an embodiment of the present invention; and

FIG. 4 is a flow diagram of a method for managing healthcare quality measure data using a quality clearinghouse in accordance with embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” might be used herein to connote different elements of methods employed, the terms should not be interpreted as implying any particular order among or between various steps herein disclosed unless and except when the order of individual steps is explicitly stated.

Various aspects of the technology described herein provide for the management of healthcare quality measure data. People who work with quality measure data desire a way to efficiently, accurately, and automatically compile quality measure data, often while the patient is still at the healthcare facility. Accordingly, one embodiment of the present invention is directed towards a system that has an identification component that identifies relevant quality measure data for a patient with a particular condition, where relevant quality measure data is data required to calculate category assignments and measurements for a standardized quality measure for the particular patient condition. A determining component determines whether the patient qualifies for the standardized quality measure for the particular condition by comparing the relevant quality measure data for the patient to criteria qualifications for the standardized quality measure for the particular condition. In addition, a populating component populates the relevant quality measure data for the qualified patient into a work queue to be reviewed, and a displaying component displays the relevant quality measure data to a user, such as an abstractor, for approval or disapproval. Further, an alerting component alerts the user or a provider if the user does not approve the relevant quality measure data for the qualified patient, and a communication component communicates the approved relevant quality measure data for the qualified patient to a quality clearinghouse.

Another aspect of the present invention is directed toward a system that has a receiving component that receives the relevant quality measure data, and a determining component that determines a recipient of the relevant quality measure data. In addition, there is a reformatting component that reformats the relevant quality measure data according to the specifications of the recipient, and a communication component that communicates the reformatted relevant quality measure data to the recipient.

The present invention also relates to methods embodied on computer-readable media for managing quality measure data related to healthcare. In one aspect of the invention, relevant quality measure data for a patient is obtained, and it is determined whether the patient meets criteria to be reviewed. If the patient does meet the criteria to be reviewed, the relevant quality measure data for the patient is populated into a work queue associated with a computing device. The relevant quality measure data for the patient is displayed to a user of the computing device, and approval of the relevant quality measure data may be received. If approval is received, the approved relevant quality measure data for the patient is sent to a quality clearinghouse. If approval is not obtained, additions, deletions, or changes to the relevant quality measure data are received to generate a revised set of relevant quality measure data. It is then determined if additional review is necessary. If additional review is necessary, the process starts over from the beginning. If additional review is not necessary, the revised set of relevant quality measure data is sent to the quality clearinghouse.

In another aspect of the invention, a computer-implemented method for managing quality measure data related to healthcare using a quality clearinghouse is provided. A set of approved relevant quality measure data is received by a quality clearinghouse. A recipient of the relevant quality measure data is selected, and the set of relevant quality measure data is reformatted to the specifications of the recipient to produce a reformatted set of relevant quality measure data. The reformatted relevant quality measure data is then sent to the selected recipient.

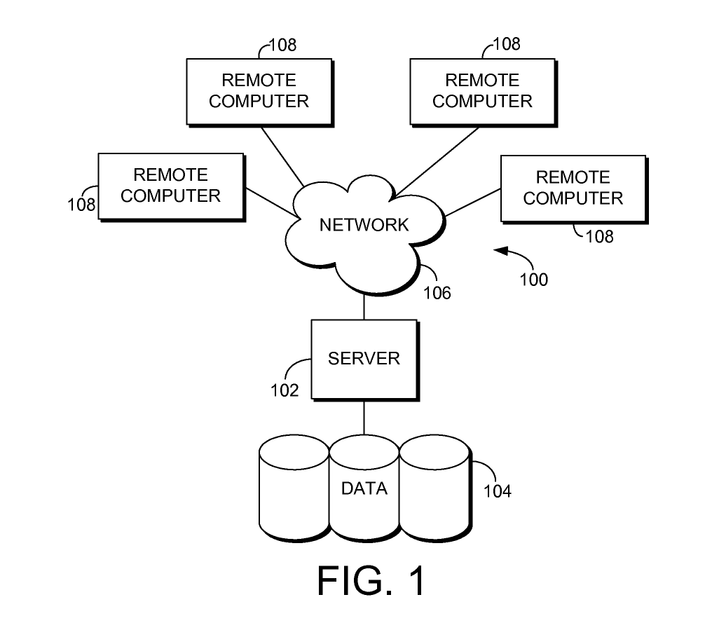

Having briefly described embodiments of the present invention, an exemplary operating environment suitable for use in implementing embodiments of the present invention is described below. FIG. 1 is an exemplary computing environment (e.g., medical-information computing-system environment) with which embodiments of the present invention may be implemented. The computing environment is illustrated and designated generally as reference numeral 100. Computing environment 100 is merely an example of one suitable computing environment and is not intended to suggest any limitation as to the scope of use or functionality of the invention. Neither should the computing environment 100 be interpreted as having any dependency or requirement relating to any single component or combination of components illustrated therein.

The present invention might be operational with numerous other general purpose or special purpose computing system environments or configurations. Examples of well-known computing systems, environments, and/or configurations that might be suitable for use with the present invention include personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention might be described in the general context of computer-executable instructions, such as program modules, being executed by a computer. Exemplary program modules comprise routines, programs, objects, components, and data structures that perform particular tasks or implement particular abstract data types. The present invention might be practiced in distributed computing environments where tasks are performed by remote processing devices that are linked through a communications network. In a distributed computing environment, program modules might be located in association with local and/or remote computer storage media (e.g., memory storage devices).

With continued reference to FIG. 1, the computing environment 100 comprises a general purpose computing device in the form of a control server 102. Exemplary components of the control server 102 comprise a processing unit, internal system memory, and a suitable system bus for coupling various system components, including database cluster 104, with the control server 102. The system bus might be any of several types of bus structures, including a memory bus or memory controller, a peripheral bus, and a local bus, using any of a variety of bus architectures. Exemplary architectures comprise Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 102 typically includes therein, or has access to, a variety of computer-readable media, for instance, database cluster 104. Computer-readable media can be any available media that might be accessed by control server 102, and includes volatile and nonvolatile media, as well as, removable and nonremovable media. Computer-readable media might include computer storage media. Computer storage media includes volatile and nonvolatile media, as well as removable and nonremovable media implemented in any method or technology for storage of information, such as computer-readable instructions, data structures, program modules, or other data. In this regard, computer storage media might comprise RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the control server 102. Combinations of any of the above also may be included within the scope of computer-readable media.

The computer storage media discussed above and illustrated in FIG. 1, including database cluster 104, provide storage of computer-readable instructions, data structures, program modules, and other data for the control server 102.

The control server 102 might operate in a computer network 106 using logical connections to one or more remote computers 108. Remote computers 108 might be located at a variety of locations in a medical or research environment, including clinical laboratories (e.g., molecular diagnostic laboratories), hospitals and other inpatient settings, veterinary environments, ambulatory settings, medical billing and financial offices, hospital administration settings, home healthcare environments, and providers' offices. Providers may comprise a treating physician or physicians; specialists such as surgeons, radiologists, cardiologists, and oncologists; emergency medical technicians; physicians' assistants; nurse practitioners; nurses; nurses' aides; pharmacists; dieticians; microbiologists; laboratory experts; laboratory technologists; genetic counselors; researchers; veterinarians; students; and the like. Providers might comprise an entity who meets the definition of a “health care provider” under the Health Insurance Portability and Accountability Act of 1996 (HIPPA). This may comprise any provider of medical or other health services, and any other person or organization that furnishes, bills, or is paid for health care in the normal course of business. The remote computers 108 might also be physically located in nontraditional medical care environments so that the entire healthcare community might be capable of integration on the network. The remote computers 108 might be personal computers, servers, routers, network PCs, peer devices, other common network nodes, or the like and might comprise some or all of the elements described above in relation to the control server 102. The devices can be personal digital assistants or other like devices.

Exemplary computer networks 106 comprise local area networks (LANs) and/or wide area networks (WANs). Such networking environments are commonplace in offices, enterprise-wide computer networks, intranets, and the Internet. When utilized in a WAN networking environment, the control server 102 might comprise a modem or other means for establishing communications over the WAN, such as the Internet. In a networked environment, program modules or portions thereof might be stored in association with the control server 102, the database cluster 104, or any of the remote computers 108. For example, various application programs may reside on the memory associated with any one or more of the remote computers 108. It will be appreciated by those of ordinary skill in the art that the network connections shown are exemplary and other means of establishing a communications link between the computers (e.g., control server 102 and remote computers 108) might be utilized.

In operation, an organization might enter commands and information into the control server 102 or convey the commands and information to the control server 102 via one or more of the remote computers 108 through input devices, such as a keyboard, a pointing device (commonly referred to as a mouse), a trackball, or a touch pad. Other input devices comprise microphones, satellite dishes, scanners, or the like. Commands and information might also be sent directly from a remote healthcare device to the control server 102. In addition to a monitor, the control server 102 and/or remote computers 108 might comprise other peripheral output devices, such as speakers and a printer.

Although many other internal components of the control server 102 and the remote computers 108 are not shown, those of ordinary skill in the art will appreciate that such components and their interconnection are well known. Accordingly, additional details concerning the internal construction of the control server 102 and the remote computers 108 are not further disclosed herein.

As used in following examples, relevant quality measure data may be defined as data elements required to calculate category assignments and measurements for any number of standardized quality measures in general, and standardized healthcare quality measures in particular. With respect to healthcare, relevant quality measure data generally addresses some aspect of quality of care delivered to defined patients by a defined individual, group of individuals, or organization(s) and relates generally to at least one of the following areas: process of care (a healthcare service provided to or on behalf of a patient), outcome of care (a patient's state of health resulting from healthcare), access to care (the patient's attainment of timely and appropriate healthcare), or patient experience of care (a patient report about observations of and participation in healthcare). Typical relevant quality measure data sources comprise clinical data (medical records, laboratory data, pharmacy data, and electronic medical records), administrative data (billing, or claims data), survey data (patient satisfaction surveys), direct observation, confidential reports from providers, and operational data (staffing levels, type of staff).

Relevant quality measure data may comprise general quality measure data or specific quality measure data. General quality measure data is collected by a healthcare facility and submitted for every patient that falls into any of the selected patient populations for national and/or state quality measures. By way of example only, and not by limitation, such general quality measure data elements may comprise admission date, birth date, event date, event type, health care organization identifier, measure set, performance measure identifier, sample, sex, and vendor tracking ID. Further, general quality measure data reported at the time of the discharge of a patient may comprise discharge date, discharge status, payment source, point of origin for admission or visit, and ICD-9-CM codes for other diagnosis, other procedure, other procedure date, principal diagnosis, principal procedure, and principal procedure date. Specific quality measure data comprises data related to specific patient populations for national or state quality measures. For example, specific quality measure data may include data related to quality measures for stroke, myocardial infarction, pneumonia, diabetes, heart failure, and the like.

National and/or state data organizations promulgate and publish specifications or qualifying criteria for standardized quality measures that relate to particular aspects of quality of care. Specifications or qualifying criteria for standardized quality measures may address pediatric conditions, neonatal conditions, chronic diseases, new technologies, ambulatory care visits, preventative care measures, home health, nursing home care, episodic care, and inpatient care. In one aspect of the invention, the relevant quality measure data must meet the qualifying criteria for the standardized quality measure before a patient is considered qualified for the standardized quality measure. By way of example, there are qualifying criteria for standardized quality measures related to acute myocardial infarction. For patients to qualify for the standardized quality measure related to acute myocardial infarction, they must, for example, have received a principal diagnosis of acute myocardial infarction, be greater than 18 years of age, and have been in a healthcare facility less than 120 days. If a patient does not meet these qualifying criteria, he will not qualify for the standardized quality measure related to acute myocardial infarction.

In yet another aspect, an individual client may promulgate qualifying criteria for the client's own quality measure. For example, a provider may specify a set of qualifying criteria that alerts the provider's clinical staff that a patient may be a candidate for the provider's quality measure. For instance, a provider may specify that if a patient presents with relevant quality measure data such as a specific elevated lab result, or a physical complaint such as left arm pain and difficulty breathing, the clinical staff will be alerted. Continuing with this example, once the clinical staff is alerted and the patient is evaluated, a quality measure in the form of a care plan for the patient may be automatically generated by the system.

Standardized quality measures may be promulgated and published by such national data organizations as Centers for Medicare and Medicaid Services Physician Quality Reporting Initiative (CMS PQRI), CMS Meaningful Use, Office of the National Coordinator (ONC), ONC-Authorized Testing and Certification Bodies (ONC-ACTB), Quality Net, The Joint Commission, State Inpatient Database (SID), Agency for Healthcare Research and Quality (AHRQ), Nationwide Inpatient Sample (NIS), and the like. In turn, state-level data organizations may comprise insurance providers such as Blue Cross/Blue Shield, state health agencies, state Medicaid agencies, hospital associations, and such.

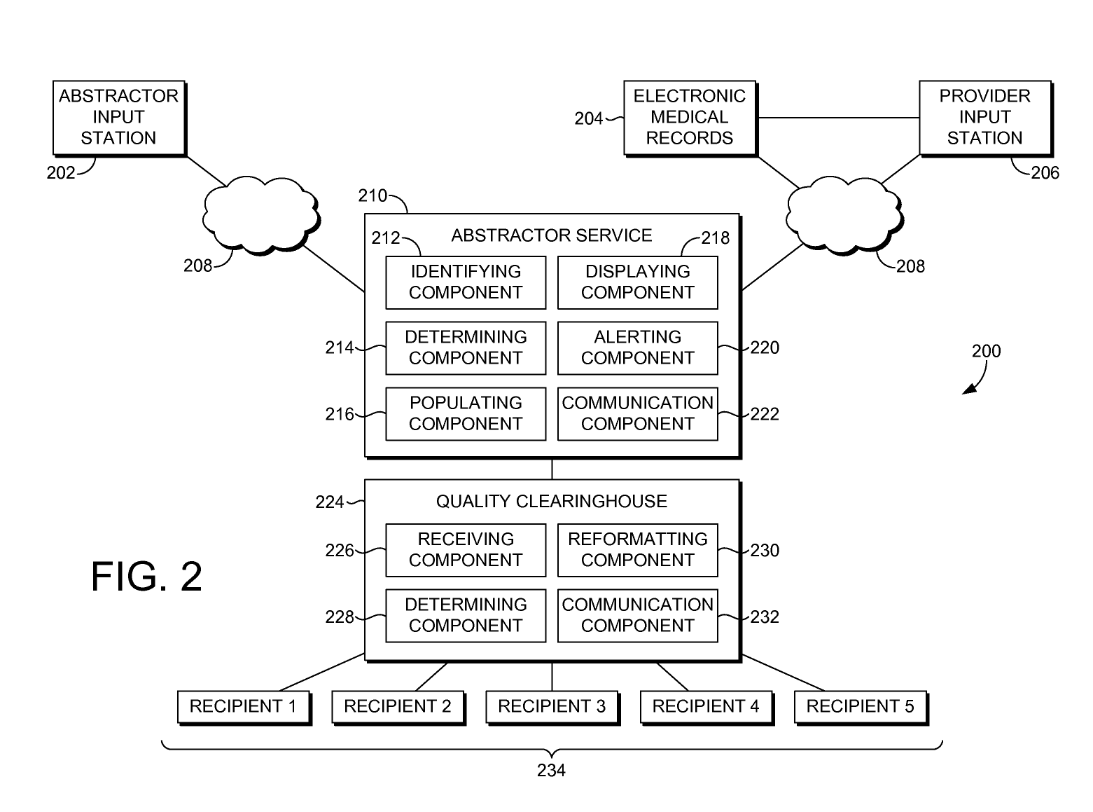

Turning now to FIG. 2, an example of system architecture 200 suitable to implement embodiments of the present invention is provided. The system architecture 200 includes an abstractor input station 202, an electronic medical record (EMR) source 204, a provider input station 206, one or more networks 208, an abstractor service 210, a quality clearinghouse 224, and a plurality of recipients 234. The network 208 may include, without limitation, one or more local area networks (LANs) and/or wide area networks (WANs). Such networking environments are commonplace in offices, enterprise-wide computer networks, intranets and the Internet. Accordingly, the network 208 is not further described herein.

As shown in FIG. 2, the abstractor service 210 comprises an identifying component 212, a determining component 214, a populating component 216, a displaying component 218, an alerting component 220, and a communication component 222. The identifying component 215 identifies relevant quality measure data for an individual patient with a particular patient condition, where relevant quality measure data is data required to calculate category assignments and measurements for a standardized quality measure for the particular patient condition. By way of example, and with reference to the example above, relevant quality measure data for a patient with an acute myocardial infarction would include the ICD-9-CM principal diagnosis code, the admission date, the birthdate of the patient, and the discharge date. Identifying component 212 may receive the relevant quality measure data, or, in another aspect, identifying component 212 may access the relevant quality measure data. As well, identifying component 212 may be active or inactive. All of these combinations are within the scope of embodiments of the invention.

In one aspect, the relevant quality measure data may be stored in the EMR 204. By way of example only, and not by limitation, the data stored in the EMR 204 may comprise electronic clinical documents such as images, clinical notes, summaries, reports, analyses, or other types of electronic medical documentation relevant to a particular patient's condition and/or treatment. Electronic clinical documents contain various types of information relevant to the condition and/or treatment of a particular patient and can include information relating to, for example, patient identification information, images, physical examinations, vital signs, past medical histories, surgical histories, family histories, histories of present illnesses, current and past medications, allergies, symptoms, past orders, completed orders, pending orders, tasks, lab results, other test results, patient encounters and/or visits, immunizations, physician comments, nurse comments, other caretaker comments, and a host of other relevant clinical information.

Continuing with respect to FIG. 2, the determining component 214 determines whether the patient qualifies for the standardized quality measure for the particular patient condition. This is done by comparing the relevant quality measure data for the patient to criteria qualifications promulgated and published by national and/or state data organizations for the standardized quality measure for the particular patient condition. Again returning to the example set forth above, relevant quality measure data for a patient with an acute myocardial infarction includes the ICD-9-CM principal diagnosis code, admission date, birthdate, and discharge date. Qualifying criteria for standardized quality measures for acute myocardial infarction include a principal diagnosis code of acute myocardial infarction, an age greater than 18 years, and a length of stay in a healthcare facility of less than 120 days. The patient qualifies for the standardized quality measure for acute myocardial infarction if the relevant quality measure data meets these criteria qualifications for this measure. Thus, the patient qualifies if the ICD-9-CM principal diagnosis code is acute myocardial infarction, the patient is greater than 18 years of age as determined by subtracting the patient's birthdate from the admission date, and the length of stay at the healthcare facility is less than 120 days as determined by subtracting the admission date from the discharge date. In yet another illustrative example, a patient may qualify for a standardized quality measure for stroke if she is 18 years or older and has a principal diagnosis code for stroke. But this same patient will be disqualified from the standardized quality measure for stroke if she is missing a discharge disposition, she was transferred to another short-term hospital, or she has another major diagnostic category (MDC) such as pregnancy, childbirth, or puerperium.

In one aspect of the invention, once it is determined that the patient qualifies for the standardized quality measure for the particular condition, the relevant quality measure data may be processed by applying programmed quality measure algorithms to the data. These algorithms may be promulgated and published by national and/or state data organizations, or the algorithms may be developed by entities other than national and/or state data organizations.

The populating component 216 populates the relevant quality measure data for the qualified patient into a work queue to be reviewed, where the work queue may be associated with the abstractor input station 202. An abstractor may be defined as a person with expertise in processing data elements in general, and patient level data elements in particular. As well, the displaying component 218 displays the relevant quality measure data for the qualified patient to a user, such as an abstractor, for approval or disapproval. In one aspect, approval will be received if the user of the abstractor input station 202 determines that all of the needed relevant quality measure data is populated into the work queue. In yet another aspect, approval may be received if the set of quality measure data comprises general quality measure data. In still another aspect, approval may be received if general quality measure data is present along with specific quality measure data.

On the other hand, approval will not be received if there is missing documentation and/or data entry errors. In this case, an alert may be automatically generated by the alerting component 220 that notifies the user to the missing data elements and/or data entry errors. Additions, deletions, or changes to the quality measure data may then be made by the user to generate a revised set of relevant quality measure data which may be subject to additional review. In one aspect, the additions, deletions, or changes to the set of relevant quality measure data may be entered manually by the user. As well, the additions, deletions, or changes may be made in response to supplemental data from external data sources. By way of example only, supplemental data from external data sources may comprise paper reports, interpretations and observations from the user, data from other electronic medical record stores, data entered by a provider, and the like. Continuing, if additional review is needed, a provider may be alerted by the alerting component 220 to enter missing or needed data into the EMR 204 by using the provider input station 206. Or the provider may be alerted by the alerting component 220 to input the missing or needed data directly to the abstractor service 210 by using the provider input station 206. The revised set of relevant quality measure data is then sent to the quality clearinghouse 224 after it is determined that no additional review is necessary.

In one aspect of the invention, the abstractor service 210 may be employed at a point when the patient is currently admitted to a healthcare facility; this is known as concurrent abstraction. Concurrent abstraction allows for several advantages. For example, if approval is not received because a healthcare provider has failed to provide certain relevant quality measure data and/or failed to undertake certain interventions, the alerting component 220 can alert the provider at a point in time when the provider still has the ability to interact with the patient and obtain the needed relevant quality measure data or initiate the needed interventions. The alert may be created manually or automatically by the alerting component 220 in various aspects of the invention. The alert may be created manually, for example, by the user manually entering the alert upon noticing the data omissions. Alternatively, the alert may be automatically generated by the alerting component 220 if certain required data elements are missing. The alert may be delivered via a number of channels, such as, for example, an electronic mail message, or a client application. In another aspect, concurrent abstraction allows the user to manually initiate a care plan for the patient when the patient is admitted to the healthcare facility.

The approved relevant quality measure data for the qualified patient is then sent to the quality clearinghouse 224 by the communication component 222. In one aspect, approved relevant quality measure data may be sent after the patient is discharged from the healthcare facility following an inpatient stay. In this instance, the relevant quality measure data sent to the quality clearinghouse 224 may comprise the relevant quality measure data generated during the patient's current stay at the healthcare facility plus the relevant quality measure data generated upon discharge of the patient from the healthcare facility. In another aspect, the relevant quality measure data sent to the quality clearinghouse 224 comprises an episode of care for the patient, where the episode of care includes services provided by a healthcare facility in the continuous course of care of a patient with a health condition. The episode of care may cover the sequence from emergency room through inpatient stay to outpatient services. In yet another example, relevant quality measure data may be sent to the quality clearinghouse 224 after a provider has had contact with the patient, whether that be, for example, during a home health visit, a screening, or an office visit.

Turning now to the quality clearinghouse 224 in FIG. 2, the quality clearinghouse 224 comprises a receiving component 226, a determining component 228, a reformatting component 230, and a communication component 232. Approved relevant quality measure data from the abstractor service 210 is received by the receiving component 226. The determining component 228 selects a first recipient of the relevant quality measure data, where the first recipient may comprise a national and/or state data organization, or an individual client. By way of example only, and not by limitation, if the set of relevant quality measure data concerns a patient who has experienced a stroke, the recipient that is selected will have promulgated and published standardized specifications related to strokes. The reformatting component 230 may calculate additional metrics and reformat the set of quality measure data to the specifications of the first recipient to produce a reformatted set of relevant quality measure data. The communication component 234 then sends the reformatted set of relevant quality measure data to the first recipient.

In one aspect of the invention, the quality clearinghouse 224 may be associated with EMR 204 that stores a set of data for the patient. As well, the quality clearinghouse 224 may be associated with the plurality of recipients 234 where the plurality of recipients 234 comprise any number of national and/or state data organizations as outlined above. In another aspect, a second recipient is selected by the determining component 228, the relevant quality measure data is reformatted to the specifications of the second recipient by the reformatting component 230, and the reformatted set of relevant quality measure data is sent to the second recipient by the communication component 234. It is to be understood that the quality clearinghouse 224 may be configured to send reformatted relevant quality measure data to any number of recipients where recipients comprise national and/or state data organizations, or individual clients.

In another aspect, the receiving component 226 may receive a plurality of sets of relevant quality measure data for a plurality of different patients. A first recipient may be selected by the determining component 228, and the relevant quality measure data may be aggregated and reformatted to the specifications of the first recipient by the reformatting component 230. The reformatted set of relevant quality measure data may then be sent to the first recipient by the communication component 232. In yet another aspect, the receiving component 226 may receive a set of relevant quality measure data, and a plurality of recipients may be selected by the determining component 228 to receive the relevant quality measure data. The reformatting component 230 reformats the set of relevant quality measure data to the specifications of each recipient to produce a plurality of sets of reformatted relevant quality measure data. The plurality of sets of reformatted relevant quality measure data are then sent to the appropriate recipients by the communication component 232.

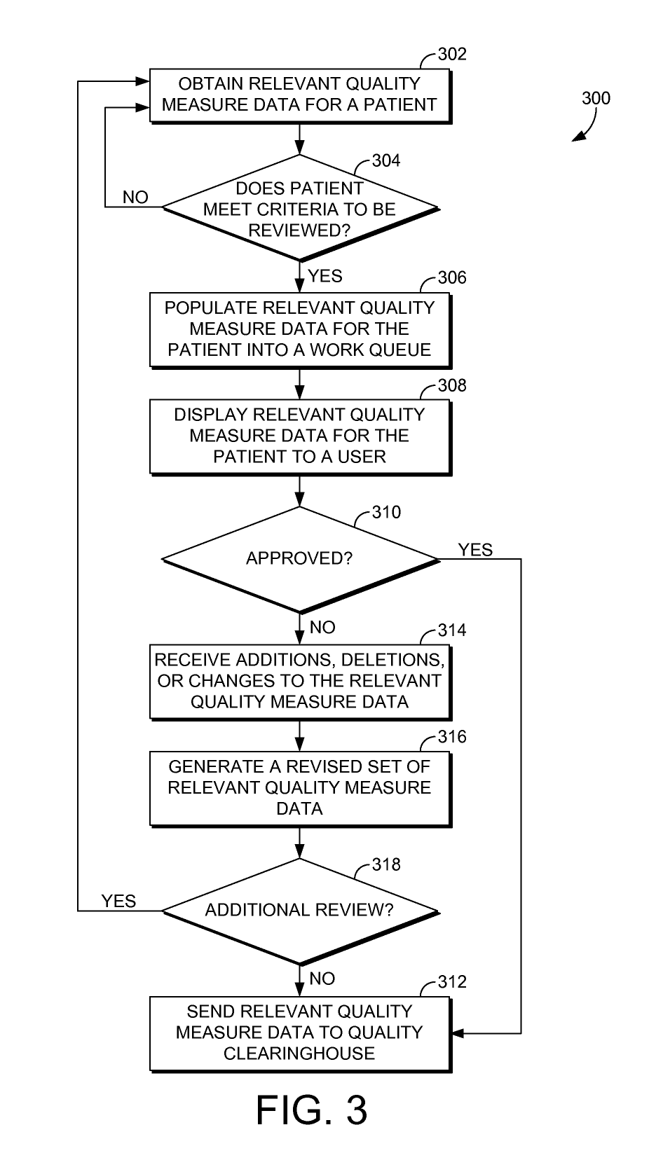

With reference to FIG. 3, a flow diagram is illustrated showing a method 300 for managing healthcare quality measure data for a patient. Initially, a set of relevant quality measure data for a patient with a particular patient condition is obtained at block 302. At block 304, a determination is made whether the patient meets the criteria to be reviewed. In one aspect, the patient meets the criteria to be reviewed if the relevant quality measure data for the patient meets the criteria qualifications for the standardized quality measure for the particular patient condition as outlined above. If the patient meets the criteria to be reviewed, the set of relevant quality measure data for the qualified patient is populated into at least one work queue at block 306, where the at least one work queue may be associated with a computing device. If the patient does not meet the criteria to be reviewed, the process starts over at the beginning.

At block 308, the set of relevant quality measure data is displayed to a user of the computing device, while at block 310, approval of the set of relevant quality measure data for the patient may be received. If approval is received, the relevant quality measure data is sent to a quality clearinghouse at block 312. If approval is not obtained, additions, deletions, or changes to the relevant quality measure data are received at block 314 to generate a revised set of relevant quality measure data at block 316. At block 318 it is determined if additional review is necessary. By way of example, it may be determined that additional review is necessary if a provider has failed to provide needed data for the patient. The provider may supply the needed data by entering it into the EMR. At this point, the process starts over from the beginning. If additional review is not necessary, the revised set of relevant quality measure data is sent to the quality clearinghouse at block 312.

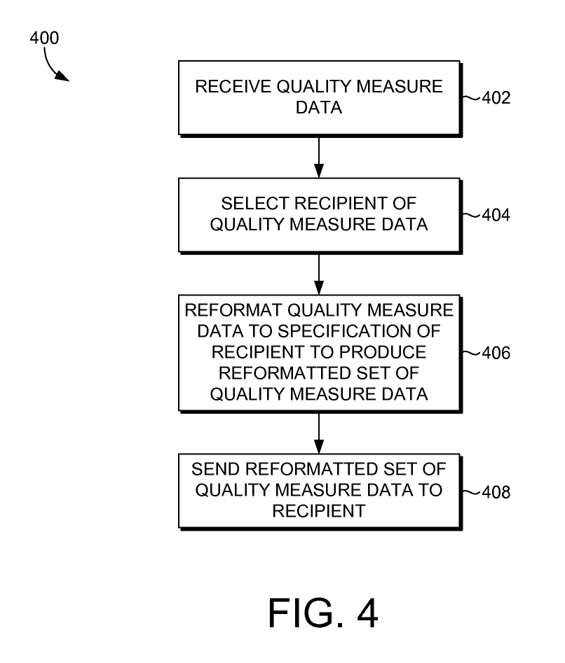

Turning now to FIG. 4, an illustrative flow diagram is shown of a method 400 for managing healthcare quality measure data for a patient using a quality clearinghouse. Initially, a set of approved relevant quality measure data for a patient is received at block 402. At block 404, a first recipient of the set of relevant quality measure data is selected. By way of example only, and not by limitation, if the set of relevant quality measure data concerns a patient who has experienced a stroke, the recipient that is selected will have promulgated and published standardized specifications related to strokes. At block 406, the set of relevant quality measure data is reformatted to the specifications of the first recipient to produce a reformatted set of relevant quality measure data for the first recipient. At block 408, the reformatted set of relevant quality measure data is sent to the first recipient.

By way of illustrative example, and not by limitation, fictitious patient Mike Gonzoles is a 43-year-old male who is admitted to a healthcare facility and diagnosed with an acute, non-hemorrhagic, cerbrovascular accident, commonly known as a stroke. Upon admission, labs are drawn, results of the labs are documented, diagnoses are listed, current problems are noted, orders are written and entered, and a medication history is documented. This set of data is stored in the electronic medical records (EMR) associated with the healthcare facility along with other data concerning Mr. Gonzoles, such as, for example, administrative data related to his admission. At a point while Mr. Gonzoles is still residing at the healthcare facility, relevant quality measure data related to the stroke is identified by an abstractor service and a determination is made that Mr. Gonzoles qualifies for the standardized quality measure for strokes. This could occur, for example, if relevant quality measure data includes an ICD-9-CM principal diagnosis code of stroke, and Mr. Gonzoles' birthdate indicates that he is over 18 years of age. In one embodiment, this may be done by the determining component 214 shown in FIG. 2. The set of relevant quality measure data is populated into a work queue for stroke abstraction. In one embodiment, this may be done by the populating component 216 as shown in FIG. 2. This work queue is associated with a computing device and displayed to an abstractor. In one aspect of the invention, this may be done by the displaying component 218 shown in FIG. 2.

As an example, the work queue may display the following query, “When is the earliest physician/APN/PA documentation of comfort measures only?” If relevant quality measure data exists regarding this query, it will be processed and displayed to the abstractor. The abstractor approves the relevant quality measure data and moves on to the next query. In another example, the work queue may display the following query, “What type of venous thromboembolism (VTE) prophylaxis was documented in the medical record?” If relevant quality measure data exists regarding this query, it will be processed and displayed to the abstractor. If the physician inadvertently forgot to document what type of VTE prophylaxis was used, or forgot to order VTE prophylaxis, the system can automatically alert the physician to the omission, or the abstractor can manually alert the physician. In one embodiment this may be done by the alerting component 220 shown in FIG. 2. After receiving the alert, the provider can input the needed information into the EMR or provide it directly to the abstractor service. In yet another example, the work queue may display the query, “During this hospital stay, was the patient enrolled in a clinical trial in which patients with the same condition as the measure set were being studied?” If relevant quality measure data does not exist regarding this query, the abstractor may answer the query based on external data sources such as a paper order.

Continuing on with the same example, the set of relevant quality measure data related to Mr. Gonzoles' stroke is sent to the quality clearinghouse after Mr. Gonzoles is discharged from the healthcare facility. The quality clearinghouse selects CMS and The Joint Commission as recipients of the set of relevant quality measure data. This may be done, in one embodiment of the invention, by the determining component 228 as shown in FIG. 2. Because these regulatory organizations require different data elements related to stroke based upon their qualifying criteria for the standardized quality measure data, the quality clearinghouse reformats the set of relevant quality measure data to the specifications of CMS and The Joint Commission to produce two sets of reformatted relevant quality measure data. This may be done, for example, by the reformatting component 230 as shown in FIG. 2. The two sets of reformatted relevant quality measure data are then sent to the appropriate recipient. In one aspect of the invention, this may be done by the communication component 232 of FIG. 2.

It will be understood that certain features and sub-combinations of utility may be employed without reference to features and sub-combinations and are contemplated within the scope of the claims. Furthermore, the steps performed need not be performed in the order described.

The invention claims is:

1. One or more computer storage media having computer-executable instructions embodied thereon for performing a method for managing healthcare quality measure data, the method comprising:
obtaining relevant quality measure data for a patient with a particular patient condition, where relevant quality measure data is data required to calculate category assignments and measurements for a standardized quality measure for the particular condition;
determining whether the patient qualifies for the standardized quality measure for the particular patient condition by comparing the relevant quality measure data for the patient to criteria qualifications for the standardized quality measure for the particular condition;
populating the relevant quality measure data for the qualified patient into at least one work queue, where the at least one work queue is associated with a computing device;
displaying the relevant quality measure data for the qualified patient to a user of the computing device;
receiving approval of the relevant quality measure data for the qualified patient from the user; and
sending the relevant quality measure data for the qualified patient to a quality clearinghouse.

2. The method of claim 1, wherein the user is an abstractor.

3. The method of claim 1, wherein the relevant quality measure data is stored in an electronic medical record source.

4. The method of claim 1, wherein the method begins while the patient is currently admitted to a healthcare facility.

5. The method of claim 4, wherein the user can alert a provider if additional relevant quality measure data is needed.

6. The method of claim 1, wherein approval will not be received if there is missing documentation or data entry errors.

7. The method of claim 1, wherein the user can make changes to the relevant quality measure data.

8. The method of claim 1, wherein the approved relevant quality measure data is sent to the quality clearinghouse after the patient is discharged from the healthcare facility.

9. The method of claim 1, wherein:
the approved relevant quality measure data is received by the quality clearinghouse,
the quality clearinghouse selects a first recipient,
the quality clearinghouse reformats the approved relevant quality measure data to the specifications of the first recipient to produce a reformatted set of approved relevant quality measure data; and
the quality clearinghouse sends the reformatted set of approved relevant quality measure data to the first recipient.

10. One or more computer storage media having computer-executable instructions embodied thereon for performing a method for managing healthcare quality measure data, the method comprising:
obtaining relevant quality measure data for a patient with a particular patient condition, where relevant quality measure data is data required to calculate category assignments and measurements for a standardized quality measure for the particular condition;
determining whether the patient qualifies for the standardized quality measure for the particular patient condition by comparing the relevant quality measure data for the patient to criteria qualifications for the standardized quality measure for the particular condition;
populating the relevant quality measure data for the qualified patient into at least one work queue, where the at least one work queue is associated with a computing device;
displaying the relevant quality measure data for the qualified patient to a user of the computing device;
receiving additions, deletions, or changes to the relevant quality measure data for the qualified patient;
generating a revised set of relevant quality measure data for the qualified patient; and
sending the revised set of relevant quality measure data for the qualified patient to a quality clearinghouse.

11. The method of claim 10, wherein the revised set of relevant quality measure data comprises general quality measure data and specific quality measure data.

12. The method of claim 10, wherein the revised set of relevant quality measure data is related to at least one of process of care, outcome of care, access to care, or patient experience of care.

13. The method of claim 10, wherein the additions, deletions, or changes are made in response to paper reports, interpretations and observations of the user of the computing device, or data from other electronic medical record sources.

14. The method of claim 10, wherein:
the revised set of relevant quality measure data is received by the quality clearinghouse,
the quality clearinghouse selects a first recipient,
the quality clearinghouse reformats the revised set of relevant quality measure data to the specifications of the first recipient to produce a reformatted set of relevant quality measure data; and
the quality clearinghouse sends the reformatted set of relevant quality measure data to the first recipient.

15. One or more computer storage media having computer-executable instructions embodied thereon for performing a method for managing healthcare quality measure data, the method comprising:
receiving a set of relevant quality measure data;
selecting a first recipient of the set of relevant quality measure data;
reformatting the set of relevant quality measure data to the specifications of the first recipient to produce a reformatted set of relevant quality measure data for the first recipient; and
sending the reformatted set of relevant quality measure data to the first recipient.

16. The method of claim 15, wherein a second recipient is selected, and the set of relevant quality measure data is reformatted to the specifications of the second recipient to produce a reformatted set of relevant quality measure data for the second recipient, and the reformatted set of relevant quality measure data is sent to the second recipient.

17. The method of claim 15, wherein a plurality of sets of relevant quality measure data are received.

18. The method of claim 17, wherein the plurality of sets of relevant quality measure data are aggregated and reformatted to the specifications of a first recipient to produce a reformatted set of relevant quality measure data for the first recipient, and the reformatted set of relevant quality measure data is sent to the first recipient.

19. The method of claim 15, wherein a first plurality of recipients are selected, and the set of relevant quality measure data is reformatted to the specifications of the first plurality of recipients to produce a first plurality of sets of reformatted relevant quality measure data for the first plurality of recipients, and further wherein, the first plurality of sets of reformatted relevant quality measure data are sent to the first plurality of recipients.

20. The method of claim 15, wherein reformatting comprises calculating additional metrics on the set of relevant quality measure data and organizing the set of quality measure data into the proper format.
